(19) United States
(12) Patent Application Publication
(10) Pub. No.: US 2003/0097942 A1
(43) Pub. Date: May 29, 2003

(54) Method and device for coupling in/out a cylinder in a printing machine

(76) Inventors: Jurgen Scholzig, Mainz-Finthen (DE); Reinhold Guba, Weiterstadt (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/168,994

(22) PCT Filed: Dec. 13, 2000
(86) PCT No.: PCT/EP00/12636

(30) Foreign Application Priority Data
Dec. 22, 1999 (DE) 19962421.6

(51) Int. Cl. B41F 13/008

(52) U.S. Cl. 101/184; 101/216

(57) ABSTRACT

The invention pertains to a method and device for coupling/decoupling a cylinder in a printing machine. The problem of the invention is to provide a method and device that can simplify the coupling process. The problem is solved by placing a bearing bushing 11 in a fixed bearing 28, which presents the spindle sleeve 10, which can be axially displaced in a longitudinal guide 27, and which can be coupled to the end 8 of the cylinder 3.

### DESCRIPTION

The invention pertaining to a method and device for coupling/decoupling a cylinder according to the preambles of the main claim and the subordinate claim.

### STATE OF THE ART

A method and device of this type are known from DE 195 37 421 C1. The cylinder here can be connected in a manner that allows disconnection on the drive side by means of a coupling consisting of first and second clutch disks. The first clutch disk is connected without rotational play to the drive wheel and the second clutch disk is connected without rotational play to the cylinder journal. Both clutch disks can be axially shifted with respect to each other by means of a work cylinder to which pressure can be applied. In the process, a lower pressure is applied to the work cylinder during the coupling process than the final pressure which is applied in the coupled state. The first clutch disk is in functional connection with a control valve, where this control valve can be actuated by the second clutch disk in such a way that during the coupling to the work cylinder, the control valve contains a pressure medium and the control valve is closed in the coupled state.

From EP 0 714 767 A1, a device for coupling a rotatary cylinder in a printing machine is known, where the drive wheel is fixed during the removal of the cylinder. The cylinder journal of the rotatary cylinder is arranged in the frame, formed by two half-shells, in an openable bearing. The bearing is provided with a bore in a bearing bushing, where the bore is concentric with the cylinder axis. A hollow shaft rotates in the bore without play, and a control shaft that can be axially displaced is arranged in said hollow shaft, where each control shaft and the associated cylinder journal are connected by means of coupling halves. On the end, the drive wheel is attached to the hollow shaft, and between the hollow shaft and the control shaft, an additional gear is arranged, with clearance, which compensates for shaft misalignment. The hollow shaft has internal teeth, and the control shaft has two external sets of teeth that cooperate with the internal teeth, and can be rotated with respect to each other.

From DE 296 17 401 U1, a device is known for the connection/disconnection of roller elements of a printing machine. By the axial shifting of a journal, using a tensioning spindle which passes through the roller body, the coupling of the roller and bearing is achieved. On one side, the tensioning spindle can be screwed into the first journal, and, one the other side, a tensioning screw passes through a second journal, and can be screwed into the tension spindle. The roller body presents, on the front side, passage bores for receiving the journal, where compression springs are arranged in the passage bores, which compression springs can be connected to the roller body by the actuation of the tensioning screws of both journals against the spring force.

A drawback of this arrangement is that all of the embodiments are relatively expensive.

### PROBLEM OF THE INVENTION

The invention is based on the problem of providing a method and device of the initially mentioned type, with which the aforementioned drawbacks are avoided, and which allow, in particular, a coupling of the cylinders and bearings, while simplifying the drive and reducing the equipment installation times.

According to the invention, the problem is solved by the embodiment characteristics of the main claim and the subordinate claim. Variants follow from the dependent claims.

A first advantage of the solution according to the invention is that the coupling process can be automated. As a result, a considerable reduction of installation time can be achieved in the replacement of a cylinder in a printing machine.

Another advantage is that the drive of the cylinder during coupling or decoupling remains fixed in the printing machine. By means of the coupling process, it is thus possible to prevent abrasion which affects the drive or the bearings.

Another advantage is that the coupling and decoupling of the cylinder can be carried out rapidly and reliably, and that a high rotational precision can be achieved by centering the cylinder.

An additional advantage is that the cylinder is designed with or without journal. A recess for the journals which penetrates the lateral frame is not necessary.

This simplifies the insertion or the replacement of the cylinder between two lateral frame walls, regardless of whether the operations are carried out manually or in automated fashion, for example, by means of a magazine and/or handling device, or industrial robots.

Finally, it is advantageous that a replacement (coupling/decoupling) of the cylinder, or alternately, of a roller, can be carried out in a manual or automated process. For example, in printing and/or coating machines, an automated replacement of the printing/coating block can be carried out, while an automated replacement of cylinders or rollers in the bearing bushings is carried out, preferably simultaneously.

### EXAMPLES

The invention will be explained in greater detail with reference to an embodiment example.

In the schematic drawings:

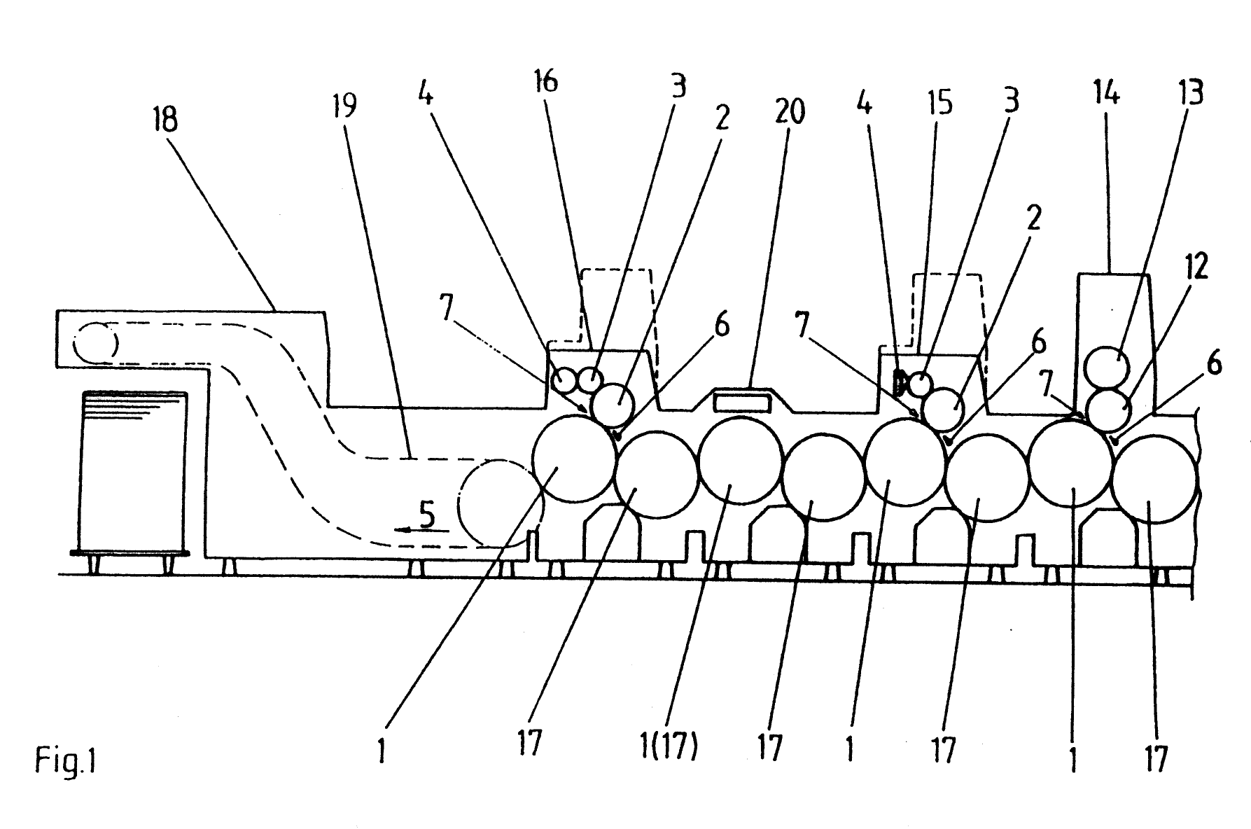

FIG. 1 represents a sheet-fed rotary printing machine with two coating machines,

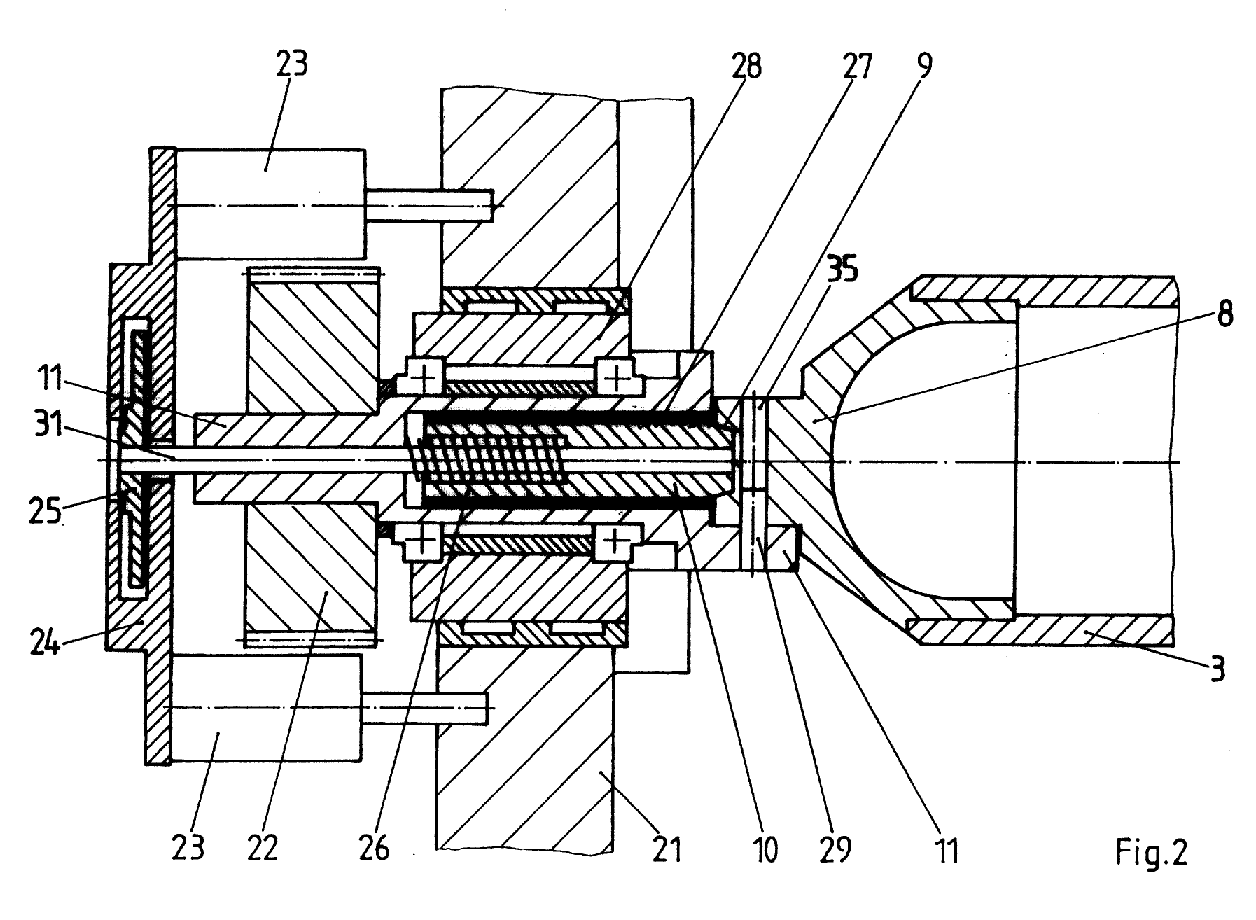

FIG. 2 represents the bearing of a cylinder on the drive side (A side),

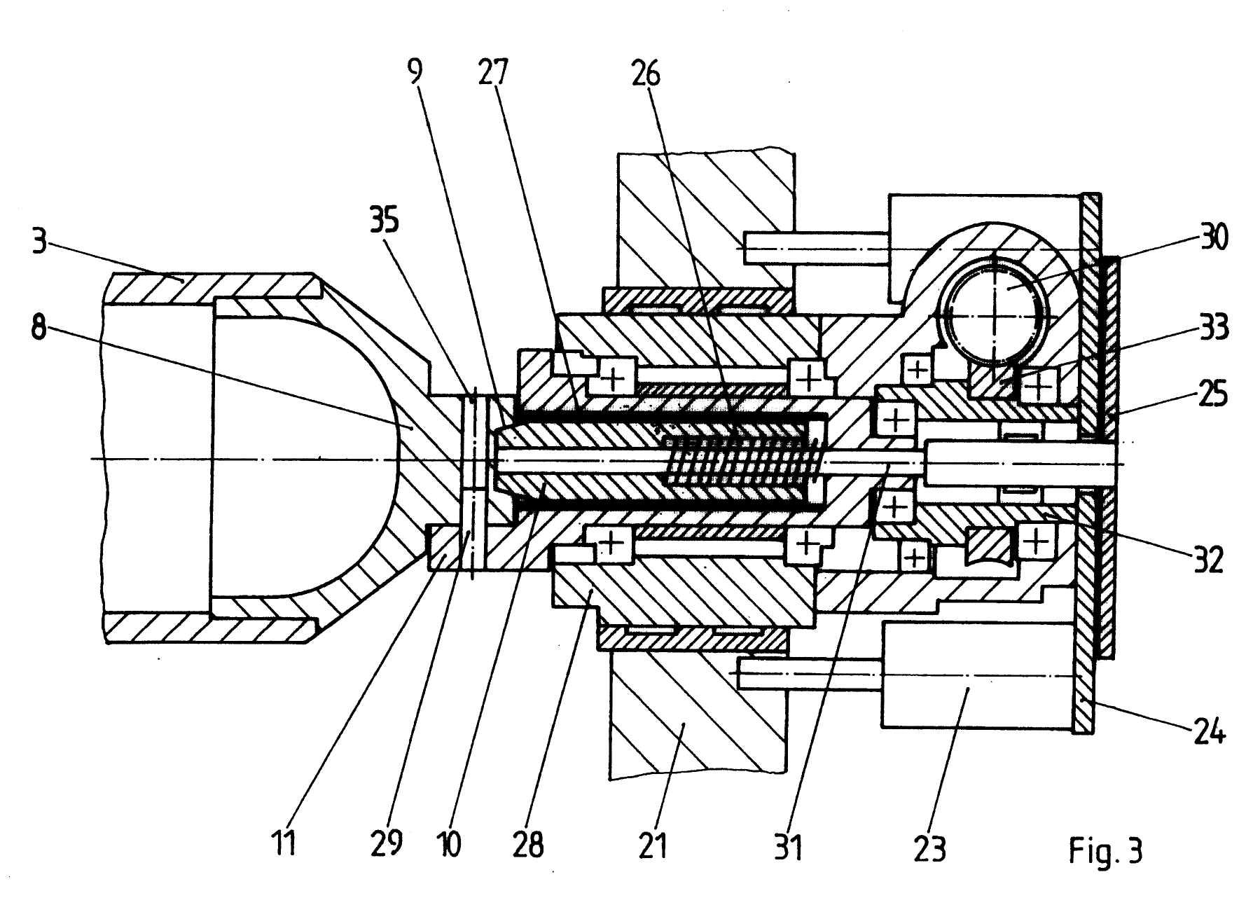

FIG. 3 represents a bearing of a cylinder (B side),

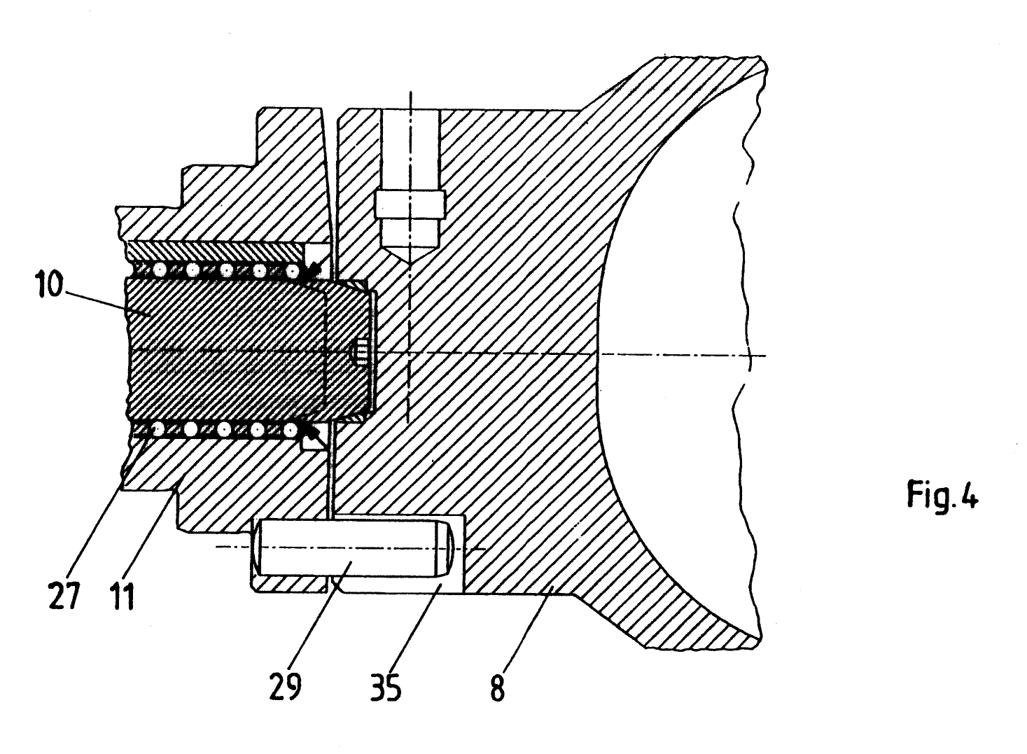

FIG. 4 represents a bearing with axial latching of a cylinder,

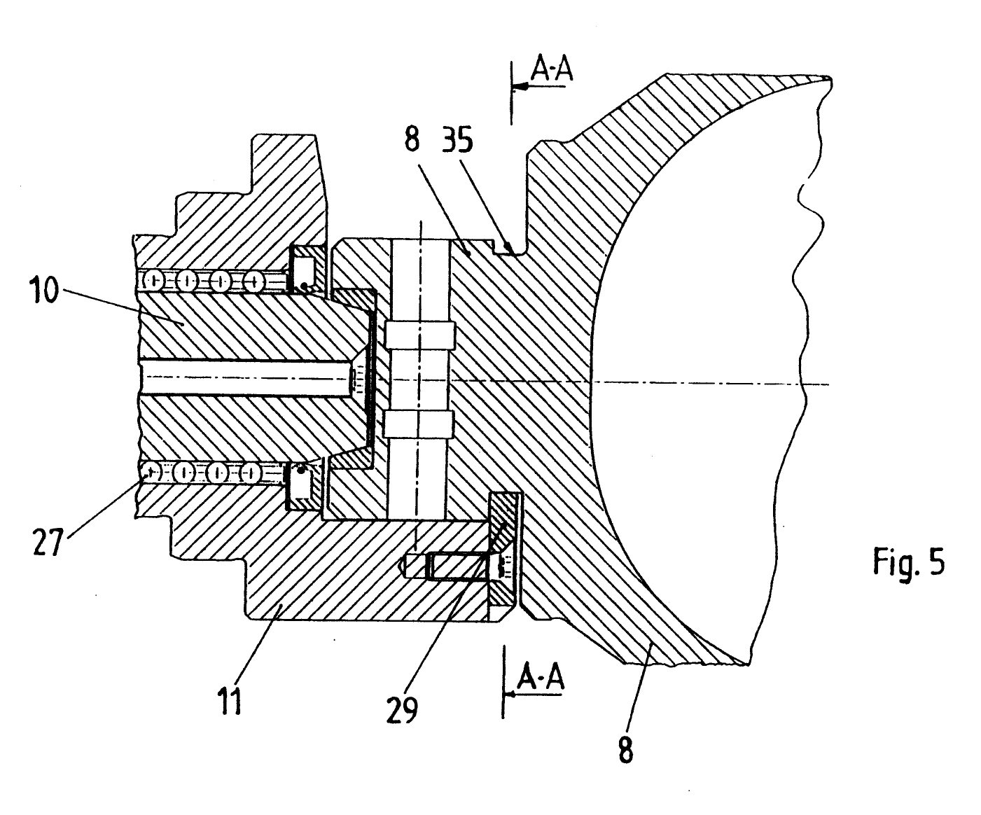

FIG. 5 represents a bearing with circumferential latching of the cylinder,

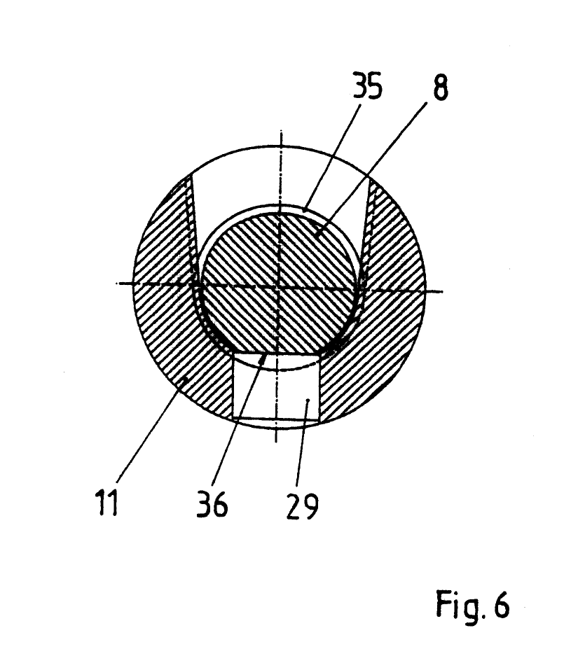

FIG. 6 is a cross section along A-A of FIG. 5.

A sheet-fed rotary printing machine may consist of, for example, several printing machines 14 for multicolor printing, and two coating machines 15, 16, which are connected downstage relative to the machine direction 5. A drying system 20 is arranged between the two coating machines 15, 16. The last coating machine 16 is followed by a sheet delivery 18, which has a circulating conveyance system 19 for transporting and depositing the sheet material on a sheet delivery stack.

Each printing machine 14 presents a plate cylinder 13 of single size, a rubber sheet cylinder 12 of single size, and a printing cylinder 1 of double size as a sheet guide cylinder. The plate cylinder 13 is associated with an inking device and optionally a damping device. Each coating machine 15, 16 presents a form cylinder 2 of single size, and an associated cylinder 3 as ink application roller and a metering system, and it is functionally connected with a printing cylinder 1 of double size as a sheet guide cylinder.

Between the printing machines 14, the first coating machine 15, the drying system 20 and the second coating machine 16, transfer cylinders 17 of double size are arranged as sheet guide cylinders. Here a printing cylinder 1 or a transfer cylinder 17, as desired, as sheet guide cylinder 2, is associated with the drying system 20. In the area of the printing zones of the rubber sheet cylinder 12 and the printing cylinder 1, as well as of the form cylinder 2 and the printing cylinder 1, sheet guide devices 6, 7 which can be actuated pneumatically are arranged before and after each printing zone, in the machine direction 5. In the first coating machine 15, the metering system 4 is formed by a chamber scraper 4 with a feed system and a return system for a liquid medium. The cylinder 3 is designed as a grid-like application roller 3 in the present example. In the second coating machine 16, the metering system 3, 4 is formed by two cylinders, in this instance, an application roller 3 and a metering roller 4.

Such a cylinder 3 presents, on both ends 8, a centering device 9. In particular, the centering device 9 is designed in the form of a cylinder or cone. Both centering devices 9 are arranged with mirror symmetry with respect to each other and so that they are aligned on the cylinder axis. According to FIG. 2, in the lateral frame 21 on one side, for example, the drive side (A side), a bearing 28 is provided, preferably a commercially available eccentric bearing. A bearing bushing 11 is arranged in the bearing 28, which, at one end, receives the end 8 of the cylinder 3, and to which, at the other end, a fixed drive 22, preferably a gear wheel is attached which can be driven. A rod 31 is arranged in the bearing bushing 11 which is aligned with the axis of the cylinder 3, and passes through the center of the bearing bushing 11. The end of rod 31 carries, in the direction toward the end 8, a concentrically arranged spindle sleeve 10 and, on the other end, a brake disk 25. The spindle sleeve 10 is arranged inside the bearing bushing 11 in a linear guide 27, preferably without clearance. In the direction toward the end 8, the spindle sleeve 10, at least in the region of the end of the spindle sleeve, is designed in the form of a cylinder, cone or truncated cone, which is adapted to the centering portion 9 of the cylinder 3. It is preferred that the surface (at the least the tip surface) of the spindle sleeve 10 have a slightly cambered form, to compensate for slight alignment errors and to support the centering of the cylinder 3.

Inside the bearing bushing 11, between the bushing and the spindle sleeve 10, a tensioning system 26 is arranged, for example, a spring system, preferably concentrically with respect to the rod 31. The brake disk 25, which is arranged on the inside of the rod 31, is a part of the brake system, which also presents a holder plate 24 and at least one, preferably several, actuation devices 23, preferably a working cylinder that can be actuated pneumatically. Alternately, one can also use working cylinders that can be actuated hydraulically.

The holder plate 24 fulfills two functions. On the one hand, it functions as a brake shoe for the brake disk 25; on the other hand, it supports actuation devices 23 which are supported on the lateral frame 21. If the bearing 28 is in the form of an eccentric bearing, then the actuation devices 23 are supported on the bearing 28 to guarantee the pivoting motion of the eccentric bearing. In a preferred embodiment according to FIG. 2, the bearing bushing 11 is designed as a half-shell bearing open on one side. The bearing bushing 11, here in the form of a half-shell bearing, receives the end 8 of the cylinder 3 and presents a locking mechanism 29 adapted to the form of the cylinder 3.

In an embodiment, the locking mechanism 29, for example, in the form of a bolt, or a bolt with spherical head, or a sphere, is arranged radially with respect to the axis of the cylinder 3 on the bearing bushing 11 (in the area of the half-shell bearing), and it is form fit to the opening or bore 35 arranged radially on the end 8, to form a positive connection (FIGS. 2, 3).

In an additional embodiment, the locking mechanism 29, for example, in the form of a bolt, is arranged with its axis parallel to the axle of cylinder 3 on the bearing bushing 11, and an opening 35 or a bore for the form-fit connection of locking mechanism 29 is arranged on each end 8 of the cylinder 3 (FIG. 4).

In an additional embodiment according to FIGS. 5 and 6, the locking mechanism 29 is arranged circumferentially on the bearing bushing 11 and, on each end 8 of the cylinder 3, an opening 35, for example, with threads or preferably in the form of a groove for the form-fit of the locking mechanism 29, is arranged. It is preferred that the half-shell bearing of the bearing bushing 11 be approximately U-shaped, and present a plate as locking mechanism 29. The plate, as locking mechanism 29, engages in the opening 35, which is designed as a circumferential groove at the opening 35 on the end 8. Here the circumferential groove in the opening 35 presents a secant-shaped abutment surface 36 which represents a circumferential form-fit connection with the plate shaped locking mechanism 29.

According to FIG. 3, in the lateral frame 21 of the other side, for example the B side—similar to the A side—a bearing 28 is arranged, preferably, a commercially available eccentric bearing. A bearing bushing 11 is located in the bearing 28 and receives the end 8 of the cylinder 3, and a rod 31, which aligned with the axis of the cylinder 3, passes through the center, inside the bearing bushing 11. In the direction toward the end of the cylinder 3, the rod 31 supports, at one end, a concentrically arranged spindle sleeve 10 and, on the other end, a brake disk 25 is arranged on the rod 31. The spindle sleeve 10 is arranged in a linear guide disk 27 in the bearing bushing 11 and is designed, in the direction toward the end 8, in the form of a cylinder, cone or truncated cone. The design of the spindle sleeve 10, in the form of a cylinder or cone/truncated cone, is formed so that is adapted to the centering portion 9 in the end 8 of the cylinder 3. In the bearing bushing 11, between the bushing and the spindle sleeve 10, and preferably concentrically with respect to the rod 31, tensioning system 26, for example, a spring system, is arranged. The brake disk 25, which is arranged at the inside on the rod 31, is again a part of a brake system, which furthermore presents a holder plate 24 and at least one, preferably several, actuation devices 23, for example, the working cylinder that can be actuated pneumatically or hydraulically. The holder plate 24 functions as a brake shoe and simultaneously carries the actuation devices 23 which are supported on the lateral frame 21.

If the bearing 28 is designed as an eccentric bearing, then the actuation devices 23 are arranged on the bearing 28 to guarantee the pivoting motion of the eccentric bearing.

The bearing bushing 11 is analogous to the A side (FIGS. 2, 4, 5, 6) and its above-mentioned embodiment variants are designed with a locking mechanism 29 for the form-fit connection of the end 8 of cylinder 3.

In the area of the brake disk 25, on the end of rod 31, second drive 30 is provided as an auxiliary drive, which is coupled to a gear 33, for example, a worm gear. The gear wheels 30 and 33 are preferably designed as a worm drive, where the auxiliary drive 30, in the case of a bearing 28 which is designed as an eccentric bearing, is arranged on the latter so that it can be pivoted. The gear 33 is connected to a hollow shaft 32, which is located in the drive 30, and through which the rod 31 passes. The hollow shaft 32 presents a freewheel 34, which is arranged on the inside at the bearing bushing 11.

The work procedure is as follows: cylinder 3 and bearing bushing 11 are decoupled.

Before insertion of the cylinder 3, the actuation devices 23 are actuated, where the actuation devices are preferably coupled by circuit technology to a central control; the bearing bushings 11 are stopped (braked until they stop moving) by means of the brake system 23, 24, 25, preferably with frictional connection. For this purpose, the holder plate 24 is moved by the actuation device 23 axially in the brake position (1^{st} pass section). When the desired position of the bearing bushings 11 has been reached, as determined by means of a sensor or, for example, a contact cam, the actuation device 23 continues to be actuated, so that the holder plate 24 can be moved by the actuation devices 23 axially in a position for decoupling (2^{nd} pass section). In this process, the holder plate 24 axially moves the brake disk 25 and the rod 31 with the spindle sleeve 10 in such a way that the holding strength of the power system 26 is overcome, and the spindle sleeve 10 is moved out of the centering portion 9. In the case of the design of the bearing bushing 11 as a half-shell bearing with locking mechanism 29, during the coupling/decoupling, the bearing bushing 11 is moved, under sensor control, by the drive 30 into a position in which the cylinder 3 is applied on the half-shell bearing of the bearing bushing 11, and the locking mechanism 29 is realized by adaptation to the form-fit connection with respect to the given end 8.

Cylinder 3 is inserted between the lateral frames 21. The actuation devices 23 release the brake disk 25, and the spindle sleeves 10, which are mutually aligned, are subjected to a force from the tensioning system 26 and moved axially in the centering line 9 of the front sides 8. As a result, tension is applied to the cylinder 3, and it is centered. Alternately, one can use, instead of the tensioning system 26 with spring force, an actuation device which can be actuated hydraulically or pneumatically, or a threaded drive, in order to generate an axially acting force.

To transfer the moments of inertia, the latches 29, as a function of the design (FIGS. 2-6), have form-fit connections with the ends 8 so that they can also be disconnected. The position for coupling or decoupling cylinder 3 with the latches 29 is preferably controlled via the drive 30 which is preferably coupled by circuit technology to a central control and actuated by a contact cam or by sensing means for positioning.

### Reference List

1 Printing cylinder

2 Form cylinder

3 Cylinder

4 Metering system

5 Conveyance direction

6 Sheet guide device

7 Sheet guide device

8 End

9 Centering portion

10 Spindle sleeve

11 Bearing bushing

12 Rubber sheet cylinder

13 Plate cylinder

14 Printing machine

15 Coating machine

16 Coating machine

17 Transfer cylinder

18 Sheet delivery

19 Conveyance system

20 Drying system

21 Lateral frame

22 Drive

23 Actuation device

24 Holder plate

25 Brake disk

26 Tensioning system

27 Linear guide

28 Bearing

29 Locking mechanism

30 Drive

31 Rod

32 Hollow shaft

33 Gear

34 Freewheel

35 opening

36 Abutment surface

1. Method for coupling/decoupling a cylinder in a printing machine with a drive and bilateral bearings, characterized in that for decoupling the cylinder, the main drive is stopped and an auxiliary drive is switched on, in that the cylinder which presents, on each end, a centering portion, and the bearing bushing which presents a force-loaded spindle sleeve, are moved by means of an auxiliary drive into a predetermined, defined position, in that the bearing bushing is then braked until it stops by means of the brake system, and the spindle sleeve is then moved axially against a force acting on the spindle sleeve, so that the spindle sleeve is decoupled from the centering portion of the cylinder, in that during the coupling the brake system releases the bearing bushing and the spindle sleeve is axially moved by means of a force, so that the spindle sleeve is axially moved in the centering portion of the cylinder to center the cylinder.

2. Device for coupling/decoupling a cylinder in a printing machine with a drive and a bearing on both sides, characterized in that in a fixed bearing (28), a bearing bushing (11) is located so that it can rotate and be coupled to at least one drive (22, 30), in that a linear guide (27) is arranged in the bearing bushing (11) which receives a spindle sleeve (10) which is formed centered in the direction of the cylinder (3), with a concentrically arranged rod (31), and in that the cylinder (3), on each front side (8), presents a centering portion (9) for the centered reception of the spindle sleeve (10), in that, on the inside of the rod (31), a brake system (23, 24, 25) which can be actuated is arranged, wherein a brake disk (25) is arranged on the rod (31), and in that between the bearing bushing (11) and the spindle sleeve (10), a force system (26) is arranged, and in that the bearing bushings (11) present a latch (29) for the form-fit connection of the front sides (8).

3. Device according to claim 2, characterized in that the bearing (28) is an eccentric bearing.

4. Device according to claim 2, characterized in that the first drive (22) is formed by a gear of the gear train of the main drive.

5. Device according to claim 2, characterized in that a second drive (30) consists of an auxiliary drive coupled to a freewheel (34).

6. Device according to claim 2, characterized in that the centering portion (9) is designed in the form of a cylinder or cone.

7. Device according to claims 2 and 6, characterized in that the type of the spindle sleeve (10) has the form of a cylinder or cone that matches the centering portion (9).
